(19) United States
(12) Patent Application Publication
(10) Pub. No.: US 2013/0264228 A1
(43) Pub. Date: Oct. 10, 2013

(54) IDENTIFICATION DEVICE AND METHOD OF MANUFACTURING A CONTINUOUS STRUCTURE

(71) Applicants: Alexandre Kollep, Lutry (CH); Wolfgang Schuh, Vohrenbach (DE)

(72) Inventors: Alexandre Kollep, Lutry (CH); Wolfgang Schuh, Vohrenbach (DE)

(73) Assignee: NESTEC S.A., Vevey (CH)

(21) Appl. No.: 13/992,943

(22) PCT Filed: Dec. 9, 2011
(86) PCT No.: PCT/EP11/72291

§ 371 Date: Jun. 10, 2013

(30) Foreign Application Priority Data
Dec. 14, 2010 (EP) 10290650.0

(51) Int. Cl. A47J 31/44; G06K 19/06

(52) U.S. Cl. CPC A47J 31/44; G06K 19/06196
USPC 206/216; 156/244.11; 156/244.19; 156/500; 235/493

(57) ABSTRACT

The invention relates to an identification device comprising at least one magnetically-responsive micro-wire (21) that is suitable for responding to an outside magnetic field, characterized in that the identification device includes a core member (7) surrounded by a protective cover member (29) and at least one micro-wire (21) being arranged between the core member (7) and the protective cover member (29).

### FIELD OF THE INVENTION

The present invention relates to the field of manufacturing devices for identifying the contents of a beverage producing device. The invention more particularly relates to an identification element that is embedded in a capsule, generally containing a pre-portioned mix or compound used in the production of a beverage. This invention also relates to a process for producing said identification element, as well as an apparatus in which said process is implemented, and the capsule produced in said process.

### BACKGROUND

For several years, beverage producing systems have been, in general, premised on the basis of portioned beverages, providing a pre-determined volume of a beverage. This has generally been accomplished through the use of a capsule, within which is contained a predetermined amount of a beverage ingredient such as ground or freeze-dried coffee, tea, hot chocolate mix, or powdered milk. While this document refers to a “capsule,” it is understood that a cartridge, packet, pod, or the like may equally be employed.

Said capsules are generally employed along with a beverage machine adapted for their use. Such machines are generally provided with means for storing and heating water, introducing the heated water into the capsule to create a beverage, and dispensing the beverage into a container for consumption. These systems have numerous advantages over more traditional forms of beverage preparation, notably their ease of use, clean operation, and the quality and consistency of the beverages produced.

Furthermore, it is known from European patent application 09164589.5 to associate a magnetically responsive identifier with the capsule for the purposes of identifying the capsule to the beverage machine into which it is inserted, generally by means of a reader. This identifier may be attached to or integrated within the structure of the capsule itself. Such electro-magnetic identification means allow the brewing machine to adapt the brewing process to the contents of the particular capsule being used, for instance by altering such factors as water temperature, water volume, or others. This permits the brewing machine to utilize capsules containing a wide variety of beverages, while at the same time optimizing the brewing process for each kind of beverage.

This electro-magnetic identification system is based upon the magnetic properties of a wire between 10 and 200 μm thick and of special composition, generally of a metallic core coated with a glass sheath, referred to here as the “micro-wire.” Said wire is embedded in or attached to an identification member, which is itself attached to or embedded within the beverage capsule. The beverage capsule, provided with a micro-wire embedded “identification device,” is inserted in the beverage machine by the operator.

The beverage machine is provided with an exciter coil for generating an alternating magnetic field, which is directed towards said micro-wire. This micro-wire responds to the magnetic field in such a way as to generally reflect it, but in an altered form that varies according to the wire's structure and material composition. This altered magnetic field generates a voltage in a second receiver coil, which is decoded by the beverage machine's internal electronics. The beverage machine thus determines the type of beverage contained within the capsule, and adjusts the brewing parameters accordingly. The capsule may optionally be provided with a plurality of such micro-wires, thereby permitting more complex signals to be generated in the receiver coils than with a single wire. This allows for more, different kinds of beverages to be encoded than with a single micro-wire.

The present system as described above is disadvantageous in several aspects. First, since the micro-wires are only about 30 μm in diameter, they are extremely fragile. Consequentially, it is difficult to produce the micro-wires and cut them to proper length for embedding them into the beverage capsule without breaking them and rendering them useless. Second, as the wires are so small, it is also difficult to actually embed them into the beverage capsules, especially in an industrial environment where manufacturing speed is of great economic importance. Third, the fragile nature of the micro-wires means that they are particularly prone to breakage by thermal stresses induced by the capsule fabrication process. Finally, there is also a need to protect the micro-wires during use of the food items contained in the beverage capsules, such as during storage of the filled capsules or during brewing of the beverage contained within them.

### SUMMARY OF THE INVENTION

It is accordingly an object of the invention to provide means by which the identification devices may be produced in a form that protects the micro-wires contained therein from damage, and possibly economically and in high volume.

Another object of the invention may be to facilitate the handling of the identification devices and their insertion into the beverage capsules during production of the latter.

A further object of the invention may be to provide means for reducing the breakage of the micro-wire due to thermal and mechanical stresses encountered during the formation of the identification devices.

A further object of the invention may be to provide means for manufacturing identification devices that are provided with a plurality of micro-wires, said micro-wires having a consistent spacing and orientation within the identification device.

A further object of the invention may be to provide means for the protection of the micro-wires from damage during the use of the beverage capsule, e.g. during storage or brewing.

According to a first aspect, the invention is directed to an identification device as described in claim 1. This identification device is advantageous in that the micro-wire or -wires are protected by both a core member and a cover member. The core member increases the micro-wire's resistance to tensile stresses, while the cover member maintains the position of the wire(s) in the specified location in the member, as well as protects them from cutting, abrasion, and contact with foreign substances. Further, the encapsulation of the at least one micro-wire by the cover member enables easier and safer handling of the identification device thus formed.

According to one feature, the micro-wire or -wires may be positioned so as to be in contact with the core member of the identification device. This arrangement is advantageous in that it provides further support to the micro-wire during the identification device manufacturing process. By positioning the micro-wire in contact with the core member, the two may be drawn through a continuous extrusion device in tandem, with the core member bearing most of the tensile force inherent in the continuous extrusion process. Furthermore, the at least one micro-wire is thus maintained in position against the core member without any possibility of moving thanks to the arrangement of the cover member.

According to another feature, the identification device is of a generally elongated shape, being provided with a longitudinal axis. More particularly, the identification device has an elongated shape along a central longitudinal axis, the core member, the at least one micro-wire, and the cover member extending along said longitudinal axis. This is advantageous in that an identification device with a generally-elongated shape, provided with a longitudinal axis, may be produced by a continuous extrusion process. This facilitates rapid and inexpensive fabrication of the identification device.

According to still another feature, the identification device is structured so that the core member extends around the central longitudinal axis, and about which axis at least one micro-wire is positioned radially offset relative to said axis. Since the micro-wire or -wires are radially offset, and preferably parallel to the axis, this yields a radial symmetry in the cross section of the identification device. This facilitates manufacture of the identification devices, as tooling designed for the manufacture of symmetrical objects is generally less expensive than that for the manufacture of asymmetrical objects.

According to still another feature, the core member of the identification device includes at least one traction-resistant element. This has the advantage of increasing the tensile strength of the identification device, making it more durable and more resistant to breakage. It is also advantageous in that the identification device will not significantly elongate during the extrusion process, improving consistency and reducing waste.

According to still another feature, the core member is provided with at least one traction-resistant element that is a non-metallic filament of bundle of filaments, a strand(s), wire(s), braid(s), cord(s) or ribbon(s). This is advantageous in that these are commonly-available, generally inexpensive materials, whose non-metallic composition will not interfere with the operation of the micro-wire.

According to still another feature, the core member includes a polymer layer that is extruded onto the traction-resistant element or elements, forming a composite structure. Especially in embodiments where a filament is present, the polymer layer serves, in conjunction with the filament and other elements of the identification device, to increase the strength of the identification device. This is advantageous in that the polymer can be employed to increase the thickness and strength of the identification device.

According to still another feature, a protective cover member comprising a polymer layer is extruded onto the core member and at least one micro-wire adjacent to the core member. This is advantageous in that it creates a protective package for the micro-wire or -wires. The micro-wire or -wires are thus protected by the protective cover member and benefit from the strength of the core member.

According to still another feature, the polymer layer of the core member and/or protective cover member is a thermoplastic polymer preferably selected from among polypropylene, polyethylene, polyester, polyamide, or any combination thereof. This is advantageous in that these materials are well-known to industry, have appropriate physical properties, are food grade, are compatible with the fabrication process employed in this invention, and are reasonably inexpensive.

According to still another feature, the identification device is provided with a plurality of micro-wires, arranged between the protective cover member and the core member and at a distance from each other. This is advantageous in that by employing a plurality of identification wires, a greater variety of codes may be employed. This enables the identification system in the beverage machine to identify a greater variety of beverages.

According to a second aspect, the invention is also directed to a method of manufacturing a continuous structure such as an identification member, as defined in claim 10. This identification member may later be employed to fabricate an electromagnetically responsive identification device for a beverage capsule. In this method, there is first provided a core member, in relation to which at least one magnetically-responsive micro-wire is arranged. About these is extruded a cover member, so as to enclose the core element and micro-wire(s) in an identification member. This has the advantage of producing an identification member in an economical, durable package.

According to one feature, the step of providing a core member more particularly comprises the following sub-steps:

providing a filament;

extruding a polymer layer about said filament.

According to another feature, the core member has an elongated shape along a longitudinal axis, thereby providing the continuous structure (e.g. identification member) with a longitudinal axis. This is advantageous in that it facilitates the continuous production of the structure by extrusion; such processes by their nature produce elongated objects.

According to still another feature, the method of manufacturing the continuous structure (e.g. identification member) includes cutting said structure along several cutting planes oriented transversally and spaced apart from each other. This results in a plurality of identification devices (e.g. tags), each being essentially a shorter version of the continuous structure. This is advantageous in that the components may then be used in the manufacture of other objects, such as beverage capsules.

According to still another feature, the method employed to manufacture the continuous structure (e.g. identification member) includes cutting said structure along transverse planes which are spaced such that the distance between two consecutive cutting planes is the same for all consecutive cutting planes. The length, therefore, of the tags that are so produced is identical. This is advantageous in that any objects using the tags can be manufactured and assembled with greater facility, as no compensation for variance in the dimensions of the identification device need be made. This is also advantageous in that, since the tags are of uniform dimension, mechanical handling and manufacturing means may be employed. This results in time and cost savings.

According to still another feature, the method of fabricating the continuous structure (e.g. identification member) includes having at least two micro-wires being positioned adjacent to the core member and at a distance from each other. This is advantageous in that maximizing the distance between the micro-wires will reduce the likelihood of interference between them.

According to still another feature, the method of fabricating the continuous structure (e.g. identification member) includes positioning the micro-wires so that they are diametrically-opposed to each other. For instance, if two micro-wires are used, they will be separated by 180° of rotation about the core member of the identification member; if three micro-wires are used, 120°; and so on. This is advantageous in that it reduces interference by placing the micro-wires at the furthest possible distance from each other, while still accounting for their quantity.

According to still another feature, the method of manufacturing the continuous structure (e.g. identification member) further comprises the step of applying a lubricating substance to the micro-wire(s) prior to positioning them in relation to the core member, such that a lubricating film is deposited on the micro-wire(s). This facilitates movement of the micro-wire(s) relative to the core member and cover member during and after extrusion. This permits the micro-wire(s) to expand and contract in response to their temperature and the temperature of the materials surrounding them. Such free expansion and contraction reduces the strain on the micro-wire(s) during the fabrication process, resulting in less distortion and breakage of the micro-wire(s). This allows the beverage machine to read the micro-wire(s) with greater accuracy and consistency.

According to still another feature, the lubricating substance applied to the micro-wire(s) is an oil-, grease-, or silicone-based substance, preferably food-grade. This selection is advantageous in that these materials have properties which are well-known to the beverage preparation art, and which are generally clean, inexpensive, and easy to use in the context of a food-processing operation.

According to a third aspect, the invention is also directed to an apparatus for the production of a continuous structure such as an identification member, as defined in claim 13. This aspect of the invention is advantageous in that it is adapted for the production of the identification member that forms the basis of the invention, as briefly mentioned above.

According to one feature, the apparatus is further provided with means for cutting the continuous structure (e.g. identification member) into sections (e.g. tags) of predetermined length. For instance, the length may be uniform for all the sections issued from the continuous structure. This is advantageous in that the pieces that issue from the apparatus are, by virtue of their uniform dimensions, better adapted to use in automated production lines, such as those that manufacture beverage capsules. The implementation of the identification members produced by said apparatus is thus facilitated by this aspect of the invention.

According to still another feature, the apparatus is further provided with means for applying a lubricating substance to the micro-wire(s) prior to positioning them in relation to a core member, such that a film of lubricant is present on the micro-wire(s). For instance, said application may be accomplished by immersing the micro-wire(s) in lubricant, spraying lubricant onto the micro-wire(s), or by running the micro-wire(s) through rollers or about a pulley or pulleys that have been themselves coated with the lubricating substance, thereby transferring it to the micro-wire(s) by contact. This is advantageous in that the beneficial effects of applying lubricant to the micro-wire(s) may be achieved with the least possible mess or waste of lubricant.

The invention is also directed to a beverage capsule according to claim 14. Such a beverage capsule is advantageous with respect to existing beverage capsule designs in that it is easier and less expensive to fabricate and to implement in a beverage machine. A beverage capsule provided with an identification device that is provided with a plurality of micro-wires has the further advantage of offering a greater variety of possible beverage codes than in existing beverage capsules.

### BRIEF DESCRIPTION OF THE DRAWINGS

FIG. 1 is a cross-sectional view of a first extrusion apparatus, having provisions for the extrusion of a core member;

FIG. 2 is a cross-sectional view of a second extrusion apparatus, having provisions for the lubrication and insertion of micro-wires and the extrusion of a cover member;

FIG. 3 is a cross-sectional view of an alternative second extrusion apparatus, including alternative means of lubricating and inserting the micro-wires;

FIG. 4 is an axonometric cutaway view of a continuous structure;

FIG. 5 is a cross-sectional view of the core member produced by the first extrusion apparatus;

FIG. 6 is a cross-sectional view of the identification device produced by the second extrusion apparatus; and

FIG. 7 is a partially-exploded cross-sectional view of a beverage capsule.

### DESCRIPTION OF THE PREFERRED EMBODIMENT

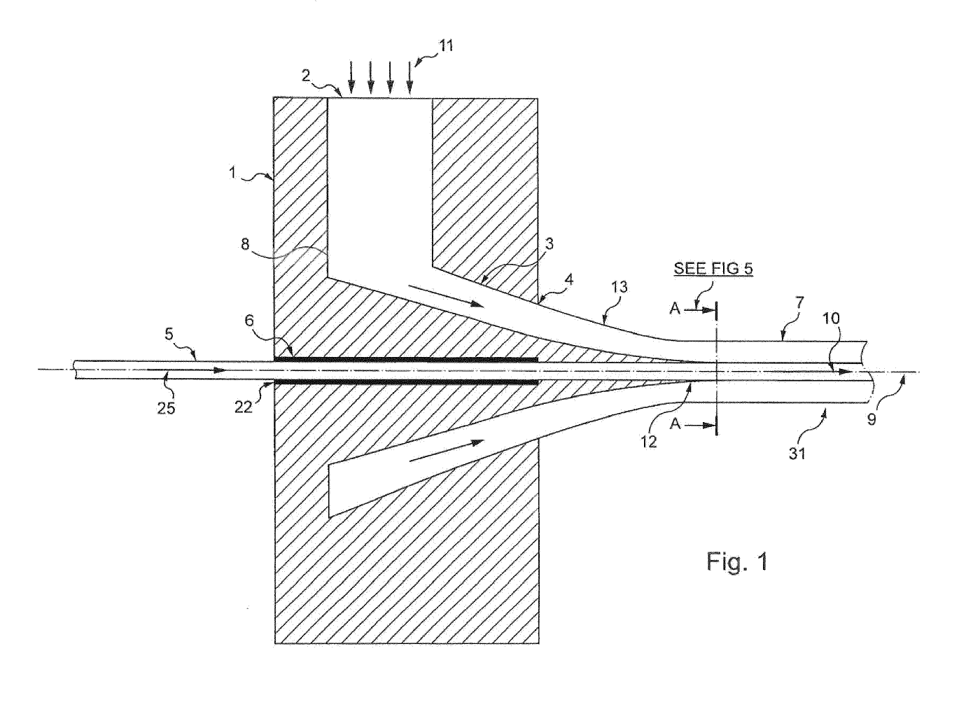

The invention will be better understood from the description which follows, which relates to a preferred embodiment, given by way of non-limiting example, and explained with reference to the accompanying FIGS. 1-5, showing respectively a first extrusion step, a second extrusion step, an alternate form of the second extrusion step, a cutaway view of an identification member, and a finished beverage capsule, respectively.

This invention comprises a first extrusion step, depicted in FIG. 1. The core of this step is the first extrusion tool 1. The first extrusion tool 1 is provided with a header 8, into which molten plastic 2 is injected. The plastic may be of any composition that is appropriate to the process and application envisioned; in the preferred embodiment, a polypropylene plastic is employed. The header 8 communicates with an annular runner 3, for example of conical longitudinal shape, which is arranged radially about the longitudinal axis 9 of the first extrusion tool 1. Alternatively, the annular runner may be replaced by a plurality of runners, all being arranged radially about axis 9. The first extrusion tool 1 is also provided with a channel 6, communicating with the exterior of the tool by aperture 22, through which a filament 5 is conducted. For example, the filament is made of glass-fiber or nylon.

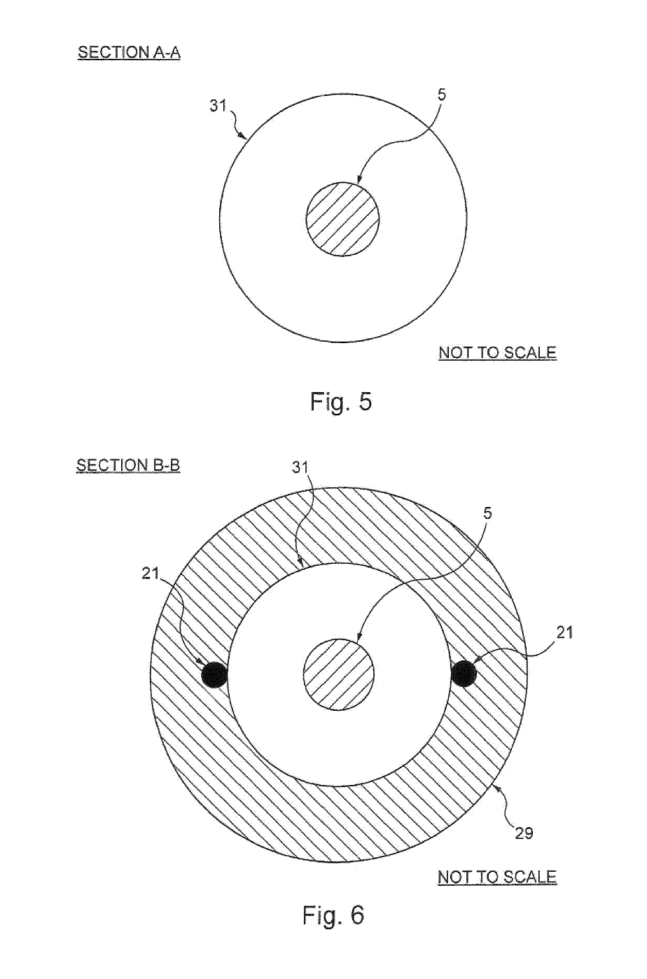

During the first part of the extrusion process, the filament 5 is drawn through the first extrusion tool 1 in direction 25 by a tensile force 10. Tensile force 10 may be generated by such means as motorized pulleys or drums. As the filament 5 is drawn through the first extrusion tool 1, a pressure 11 is applied to molten plastic 2, causing it to flow down from header 8 into the runners 3 and out nozzle 4. The viscous yet free-flowing plastic stream 13 meets the filament 5 at contact point 12, whereby it is drawn from the extrusion tool 1 by the frictional force between the filament 5 and the molten plastic 13. As the filament 5 and plastic stream 13 are drawn further from the first extrusion tool 1 by the motion of the filament 5, the plastic stream 13 envelopes the filament 5 and forms the solidified polymer layer 31, the assembly thus taking the form of core member 7. A cross-section of the core member 7 is depicted in FIG. 5, which illustrates the filament 5 and the solidified polymer layer 31. The core member 7 is allowed to cool, then stored, preferably by winding it about a drum. The core member is thus kept until it is to be used in the second extrusion step.

Before entering the second extrusion tool 14, the micro-wires 21 pass through the lubrication rollers 41. The lubrication rollers 41 are contoured such that each micro-wire 21 is contacted by the lubricating rollers 41 over the entirety of its surface. The lubricating rollers operate in conjunction with nozzles 42, which project a spray of lubricating fluid 43 towards the surface of the lubricating rollers 41. A thin film of the lubricating fluid 43 is thus uniformly applied to the surface of the micro-wires 21. The micro-wires 21 are then transferred to the second extrusion tool 14.

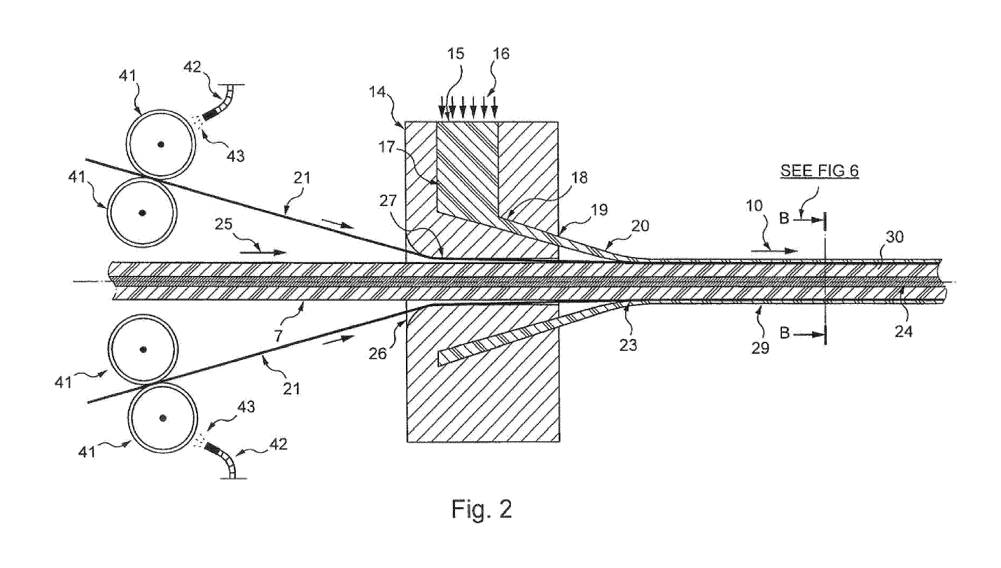

At the same time, the core member 7 is drawn from storage and into and through the second extrusion tool 14, which is depicted in FIG. 2. The core member 7 is drawn into the aperture 22, which communicates with channel 27 that traverses the second extrusion tool 14. Like the first extrusion tool 1, the second extrusion tool 14 is provided with a header 17, into which molten plastic 15 is applied under pressure 16. The header 17 communicates with an annular runner 18, for example of conical longitudinal shape, which is arranged radially about the longitudinal axis 24. Alternatively, the annular runner may be replaced by a plurality of runners, all being arranged radially about axis 24. Any material with the appropriate chemical and physical properties may be used in the second extrusion tool 14. In the preferred embodiment of the invention, polypropylene is employed.

During the second part of the extrusion process, two micro-wires 21 are drawn into the channel 27 by way of the aperture 26. The shape of the aperture 26 is configured in such a way as to minimize breakage of the micro-wires 21 while being fed into the second extrusion tool 14. The micro-wires 21 are comprised of a metallic core surrounded by a glass sheath, being approximately 30 μm in diameter. Said micro-wires 21 are magnetically-responsive, in that when exposed to a magnetic field, they respond in a fashion that may be picked up by detection means. In the preferred embodiment of the invention, two micro-wires 21 are used; a single micro-wire, or more than two micro-wires, may optionally be employed. Molten plastic 15 is extruded down through the runners 18, exiting the second extrusion tool 14 through the nozzles 19. Simultaneously, the micro-wires 21 are pressed onto the surface of the core member 7 by the aperture 26 and channel 27. The micro-wires 21 are kept in contact with the supporting core member 7 for as long a distance as possible, minimizing the stresses placed upon the micro-wires 21 and reducing breakage. As the micro-wires 21 and the core member 7 are drawn through the tool, the plastic stream 20 that issues from the nozzles 19 is drawn out from the extrusion tool 14 as a result of the friction between the core member 7 and the plastic stream 20 at the contact point 23. The overall effect is that the core member 7 is completely enrobed by the plastic stream 20, with the micro-wires 21 being enclosed between the two. As the tensile force 10 draws the core member 7 and micro-wires 21 out of the second extrusion tool 14, the plastic stream 20 cools and solidifies into a cover member 29. The solidification of the core member has the additional effect of fixing the micro-wires at a distance from each other, preferably about 1.2 mm. Due to a longitudinal distance between the contact point 23 and the nozzle 19, the cover member is deposited on the core and micro-wires while generating a minimum of stress onto the wires.

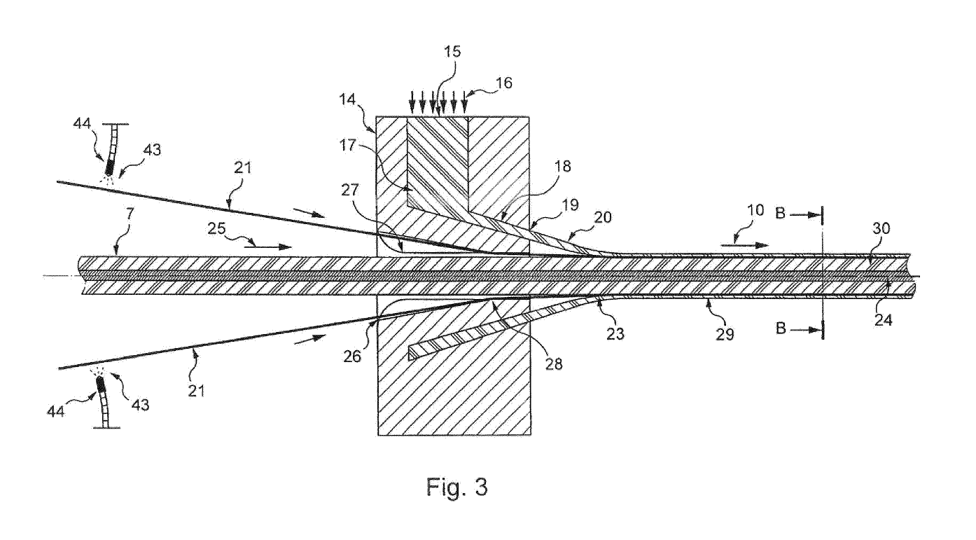

FIG. 3 depicts an alternate design of the second extrusion tool 14, in which the micro-wires 21 meet with the core member 7 at contact point 28, which is located within into channel 27 rather than at the aperture 22 as in the preferred embodiment. This lowers the angle at which the micro-wires 21 enter the aperture 26 of second extrusion tool 14, though simultaneously reducing the length of contact the micro-wires 21 have with the core member 7 in channel 27. The reduced angle makes it possible to diminish the bending stresses applied to the micro-wires 21 during the extrusion process. FIG. 3 also depicts an alternate means of applying the lubricating fluid 43 to the micro-wires 21. In the alternate means, the lubricating fluid 43 is sprayed directly onto the micro-wires 21 by nozzles 44.

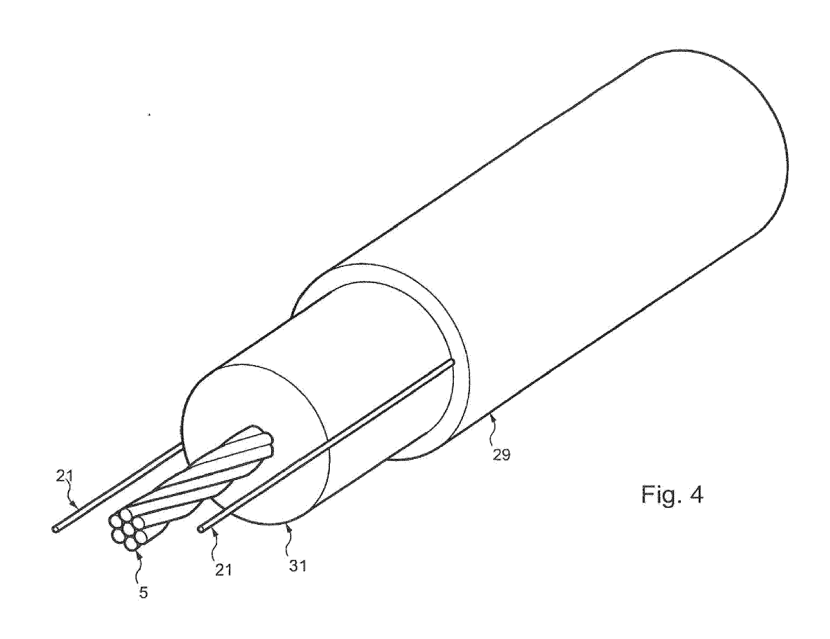

The extrusion now forms an identification member, the identification member 30. Section B-B on FIG. 2, depicted in detail in FIG. 6, shows a typical cross-section of the identification member 30, including the core member 7 (comprising filament 5 and solidified polymer layer 31), micro-wires 21, and cover member 29. FIG. 4 depicts a cutaway view of an identification member 30, with substantially the same components depicted as FIG. 6.

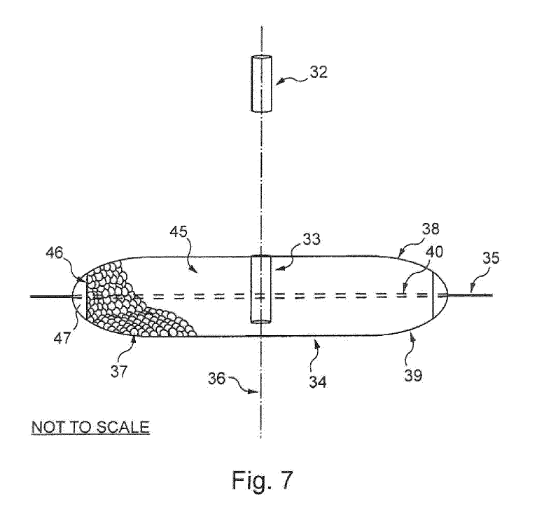

Once the identification member 30 has sufficiently cooled, it may be cut into discrete pieces, for instance by a rotating or chopping blade. The identification member 30 is thus formed into discrete components, here embodied in identification device 32 as depicted in FIG. 7. The tags 32 are of a uniform size and shape, facilitating their handling by automated means and their usage in other manufactured goods. The structure of the tags 32, including the cover member 29, the core member 7, and the filament 5, provides protection to the micro-wires 21 embedded in the identification device 32 from damage during handling and use, such as that from shock or exposure to hot water.

FIG. 7 depicts a beverage capsule 34 that incorporates the present invention. The beverage capsule 34 is composed of a top half 38 and a bottom half 39, each approximately in the shape of a bowl and, when mated together along seam 40 form a capsule in approximately the shape of a convex disc. The capsule is further provided with a chamfer 46 serving to divide the interior volume of the capsule into the beverage compartment 45 and the annular gap 46. The capsule is further provided with a lip 35, which aids in properly locating it within the beverage machine. To facilitate its fabrication, the capsule may optionally be symmetric about the axis of revolution 36. The capsule is also provided with a receptacle 33 which is molded into the top half 38 of the capsule 34. The identification device 32 is inserted into the receptacle 33, which in addition to holding the identification device 32 in place and providing structural support, protects it from heated water and beverage during the brewing process by comprising an insulating physical barrier to contact with hot water, beverage, and steam. In the preferred embodiment, the identification device 32 is press-fit into the receptacle 33, however, it may optionally be held in place by other means, such as a glued-in plug. The identification device 32 may alternately be inserted directly into the beverage ingredient 37, which is compacted around it to hold it in place. The capsule is filled with a beverage concentrate 37, here only partially depicted for clarity. The beverage ingredient 37 is preferably tightly packed and completely fills the beverage compartment 45, thereby lending additional structural support to the receptacle 33 and the identification device 32 contained therein. The annular gap 46 is preferably left empty, to facilitate the sealing of the capsule. Upon use, the consumer places the capsule 34 into the appropriate beverage machine and initiates a brewing cycle, whereby the identification device 32 is read by the beverage machine and the beverage is brewed according to the usual fashion.

Of course, the invention is not limited to the embodiment described above and shown in the accompanying drawings. Modifications remain possible, particularly as to the construction of the various elements or by substitution of technical equivalents, without thereby departing from the scope of protection of the invention. Accordingly, the scope of this disclosure is intended to be exemplary rather than limiting, and the scope of the invention is defined by any claims that stem at least in part from this disclosure.

1. An identification device comprising at least one magnetically-responsive micro-wire that is suitable for responding to an outside magnetic field, the identification device includes a core member surrounded by a protective cover member and at least one micro-wire being arranged between the core member and the protective cover member.

2. An identification device according to claim 1, wherein there is at least one micro-wire in contact with the core member.

3. An identification device according to claim 1, having an elongated shape along a central longitudinal axis, the core member, the at least one micro-wire, and the protective cover member extending along the longitudinal axis.

4. An identification device according to claim 3, wherein the core member extends around the central longitudinal axis, and about which central longitudinal axis at least one micro-wire positioned radially offset relative to the axis.

5. An identification device according to claim 1, wherein the core member includes at least one traction-resistant element.

6. An identification device according to claim 5, wherein at least one traction-resistant element is selected from the group consisting of a non-metallic filament, bundle of filaments, strand, wire, cord, braid and ribbon.

7. An identification device according to claim 5, wherein the core member includes a polymer layer extruded onto the at least one traction-resistant element.

8. An identification device according to claim 7, wherein the polymer layer is selected from the group consisting of polypropylene, polyethylene, polyester, polyamide, and combinations thereof.

9. An identification device according to claim 1, wherein a plurality of micro-wires are arranged between the protective cover member and the core member and at a distance from each other.

10. A method of manufacturing a continuous structure comprising the steps of:
providing a core member;
arranging at least one magnetically-responsive micro-wire in relation to the core member, the magnetically-responsive micro-wire or -wires being suitable for responding to an outside magnetic field; and
extruding a cover member about both the supporting core member and the magnetically-responsive micro-wire or -wires so as to form an identification member in which the at least one magnetically-responsive micro-wire is protected by the surrounding cover member.

11. The method according to claim 10, wherein the core member has an elongated shape along a longitudinal axis.

12. The method according to claim 11, comprising cutting the identification member along several transverse cutting planes spaced apart from each other so as to constitute a plurality of identification devices.

13. An apparatus for the production of an identification member, comprising:
a first member for extruding a core member;
a second member for positioning a micro-wire or -wires in relation to the core member; and
a third member for extruding a cover member about the core member and micro-wire or -wires.

14. A capsule including an identification device comprising at least one magnetically-responsive micro-wire that is suitable for responding to an outside magnetic field, the identification device includes a core member surrounded by a protective cover member and at least one micro-wire being arranged between the core member and the protective cover member.
